(19) United States
(12) Patent Application Publication
(10) Pub. No.: US 2010/0156594 A1
(43) Pub. Date: Jun. 24, 2010

(54) Biometric Lock

(76) Inventors: Jason Chaikin, Springfield, NJ (US); Seth Kenter, Springfield, NJ (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 12/339,176

(22) Filed: Dec. 19, 2008

(51) Int. Cl. G06K 9/00; G08B 29/00

(52) U.S. Cl. 340/5.53; 340/5.52; 70/283.1

(57) ABSTRACT

A lock unit is provided with a housing that includes a key-receiving body, a biometric sensor and a control circuit. The key-receiving body is arranged to receive a key therein. The biometric sensor is adapted to receive a biometric input from a user of the lock unit and to provide an output signal representative of biometric data associated with that user. The control circuit is coupled to the biometric sensor and is arranged when actuated to store the biometric data therein. The control circuit is coupled to the key-receiving body and is operative upon selected positioning of a key in the key-receiving body to actuate the control circuit. The biometric data is thereupon stored in the control circuit so that subsequent receipt of a biometric input corresponding to the stored biometric data enables the lock unit to open.

### BACKGROUND OF THE INVENTION

1. Field of Invention

This invention relates to biometric lock units and methods of programming the same, and more particularly to a biometric lock unit that is programmable with a key.

2. Description of Related Art

Various devices are available for locking a door. Typically, especially amongst residential properties, a door is locked using a lockset that contains a mechanical lock requiring a key. However, various lock devices have been introduced to the market which enable keyless entry. One such device is a biometric lock.

A typical biometric lock includes a biometric sensor, e.g., a fingerprint sensor, for receiving biometric input from a user. Such biometric input provides an output signal representative of biometric data associated with that user, whereupon the biometric data is stored in a control circuit. Subsequent receipt of a biometric input corresponding to the stored biometric data will cause the lock to open. Often, a biometric lock will include a keypad with which the lock may be programmed. The keypad may be used to enroll new users, delete existing users and create access restriction parameters associated with existing users.

A biometric lock has many advantages over a standard key-entry mechanical lock, most notably the convenience of secure entry without a key. However, there are various drawbacks associated with typical biometric locks available on the market today. They are generally difficult to install and complicated to program. They are often too expensive to be a viable option for many homeowners. Also, typical biometric locks tend to be bulky and/or have a “futuristic” look due to the presence of a keypad having a plurality of buttons and an LCD screen. A consumer who would like to have a biometric lock but prefers the traditional, elegant look of a standard mechanical key-entry lock, would be dissatisfied by the selection currently available on the market.

What is needed therefore, is a biometric lock that is relatively inexpensive and simple to install and program, and that is capable of being programmed without the use of a keypad and/or LCD screen. The lock would preferably retain, as much as possible, a look resembling a traditional key-entry mechanical lock. Optimally, its biometric components would be as inconspicuous as possible.

### BRIEF SUMMARY OF THE INVENTION

According to one aspect of the invention, a lock unit is provided having a housing including a key-receiving body, a biometric sensor and a control circuit. The key-receiving body is arranged to receive a key therein. The biometric sensor is adapted to receive a biometric input from a user of the lock unit and to provide an output signal representative of biometric data associated with that user. The control circuit is coupled to the biometric sensor and is arranged when actuated to store the biometric data therein. The control circuit is coupled to the key-receiving body and is operative upon selected positioning of a key in the key-receiving body to actuate the control circuit. The biometric data is thereupon stored in the control circuit so that subsequent receipt of a biometric input corresponding to the stored biometric data enables the lock unit to open.

### BRIEF DESCRIPTION OF SEVERAL VIEWS OF THE DRAWINGS

The invention will be described in conjunction with the following drawings in which like reference numerals designate like elements and wherein:

FIG. 1 is a front view of one exemplary lock unit according to the present invention installed in a door;

FIG. 2 is a side view of the lock unit of FIG. 1;

FIG. 3 is an exploded view of the lock unit of FIGS. 1 and 2;

FIG. 4 is a sectional view of the lock unit along line 4-4 of FIG. 2.

FIG. 5 is a variation of the sectional view of the lock unit as shown in FIG. 4, illustrating how a key is used to trigger a switch.

### DETAILED DESCRIPTION OF THE INVENTION

### Structure of the Lock Unit

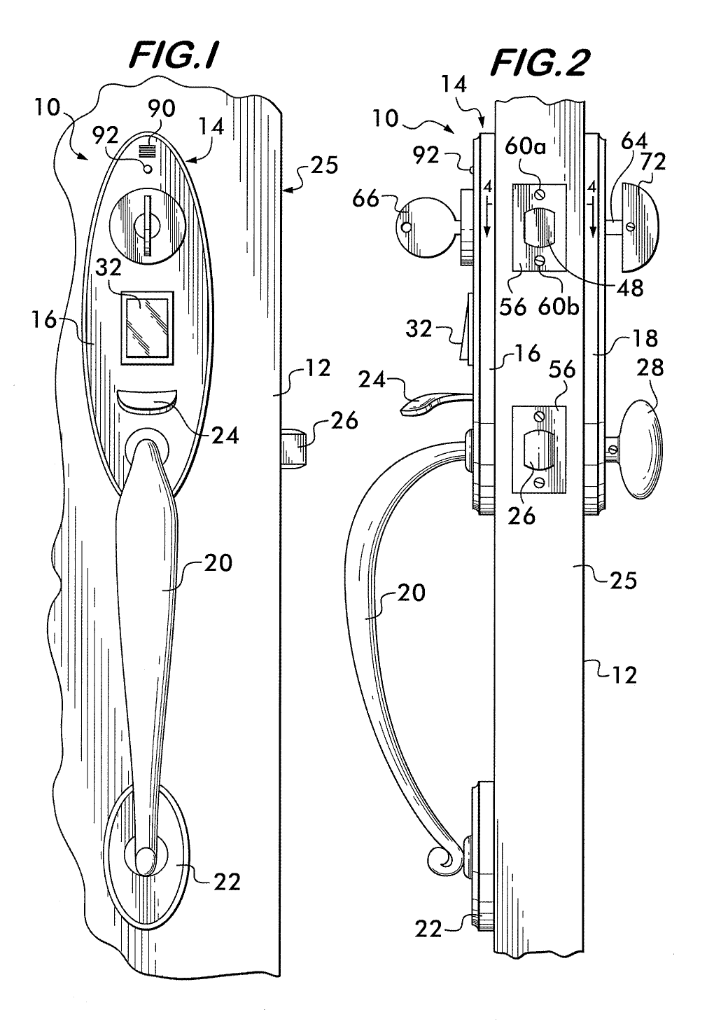

Referring to FIGS. 1, 2 and 3, there is shown one exemplary lock unit 10 according to the present invention as installed in a door 12. The lock unit 10 includes a housing 14 comprising an outer trim 16 affixed to the outside of the door 12 and an oppositely located inner trim 18 affixed to the inside of the door 12. An outwardly protruding handle 20 extends downward from a lower portion of the outer trim 16 to a protuberance 22 affixed to the outside of the door 12.

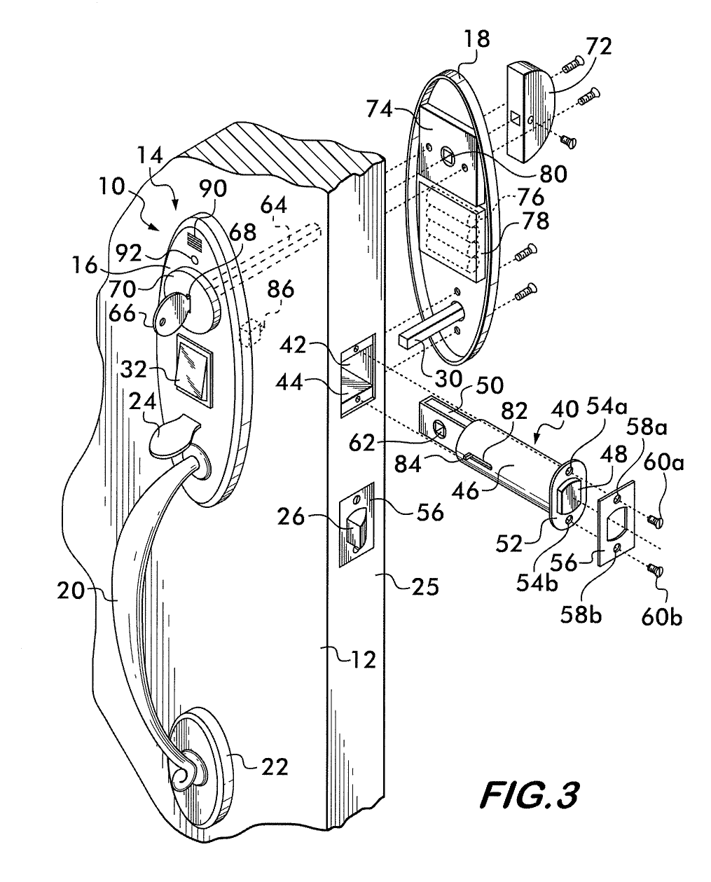

A thumbpiece 24 extends outwardly from the outer trim 16 just above the handle 20. The thumbpiece 24 is mechanically coupled to a latch bolt 26 within the body of the door 12. In its natural state, the latch bolt 26 is extended, and is adapted to engage a strike plate (not shown) affixed to a door post (not shown) that is adjacent the side face 25 of the door 12, so as to secure the door 12 in a closed position. When depressed, e.g., with a thumb, the thumbpiece 24 actuates the latch bolt 26, causing it to retract and disengage from the strike plate, thereby enabling the door 12 to be opened. A doorknob 28 is rotatably mounted onto a lower portion of the inner trim 18 and includes a knob shaft 30 (see FIG. 3) extending therefrom. The knob shaft 30 is mechanically coupled to the latch bolt 26. When rotated, the doorknob 28 actuates the latch bolt 26 in the same manner as does the thumbpiece 26. Accordingly, the latch bolt 26 can be retracted and the door 12 opened from the outside via the thumbpiece 24 or from the inside via the doorknob 28.

Within the housing 14 is a control circuit (not shown). The control circuit includes memory, a processor and any circuitry necessary to couple the various parts of the control circuit to one another as well as to various components of the lock unit 10 discussed infra.

Virtually any type of biometric sensor, e.g., fingerprint sensor, voice sensor, iris scanner or retinal scanner, may be used in conjunction with the present invention. However the preferred type of biometric sensor for typical incidental use, and the type depicted in FIGS. 1-3, is a fingerprint sensor 32, which is located substantially in the center of the outer trim 16, directly above the thumbpiece 26. The fingerprint sensor 32 is coupled to the control circuit and is adapted to receive a biometric input from a user, e.g., the user's fingerprint or thumbprint. A thumbprint is preferred because it has more minutiae points than a fingerprint. The biometric input, when captured as an image by the fingerprint sensor 32, is translated into an output signal representative of biometric data associated with the user. The control circuit is adapted to store that data so that subsequent receipt of a biometric input corresponding to the stored biometric data enables the lock unit 10 to open.

As shown in FIG. 3, the lock unit 10 includes a deadbolt assembly 40, which is secured within a hollow bore 42 having an opening 44 in the side face 25 of the door 12. The deadbolt assembly 40 includes a latch case 46 which houses a lockbolt 48. A hollow extension 50 projects from the left end of the latch case 46 and a flange 52 having top and bottom holes 54a,b surrounds the right end of the latch case 46. A faceplate 56 having top and bottom holes 58a,b lays flush against the flange 52, the holes 58a,b of the faceplate 56 being aligned with the holes 54a,b of the flange 52. Top and bottom screws 60a,b are respectively inserted through the holes 58a,b and 54a,b in order to secure the flange 52 onto the side face 25 of the door 12, and thereby securely retain the deadbolt assembly 40 within the hollow bore 42.

Translational movement (i.e., extension and retraction) of the lockbolt 48 is achieved through rotation of a rotational drive member 62 located within the hollow extension 50 of the deadbolt assembly 40. Clockwise rotation (from the perspective of facing the front of the door 12) of the rotational drive member 62 extends (i.e., locks) the lockbolt 48, while counter-clockwise rotation of the rotational drive member 62 retracts (i.e., unlocks) the lockbolt 48. A drive bar 64 is inserted through the rotational drive member 62, and operates to transfer rotational movement thereto. Rotational movement of the drive bar 64 may be achieved with a compatible key 66. The key 66 is a conventional key which is inserted through the keyway 68 of a key-receiving body 70, and then rotated within the key-receiving body 70. Rotational movement of the drive bar 64 may also be achieved by rotating a turn knob 72, which extends from the inner trim 18 and which is secured to the end of the drive bar 64. Thus, a user may lock and unlock the lockbolt 48 from inside with the turn knob 72 and from outside with the key 66.

The lock unit 10 further includes a DC motor 74 which is coupled to the control circuit and is housed inside the inner trim 18. The motor 74 is powered by batteries 76 that are held by a battery compartment 78 located within the inner trim 18. The batteries 76 are also coupled to the control circuit, providing power thereto and to all components coupled thereto requiring electrical power to operate. The motor 74 includes a centrally located hub 80 which mates with the drive bar 64. When actuated, the motor 74 is operative to provide rotational output to the drive bar 64 so as to retract the lockbolt 48, and thereby unlock, or open, the lock unit 10. In practice, the motor 74 would be actuated upon receipt of a signal from the control circuit. Such a signal would be sent upon the control circuit's receipt and recognition of an output signal representative of stored biometric data from a user who provided a biometric input to the fingerprint sensor 32.

The deadbolt assembly 40 additionally includes a longitudinal slot 82 along a portion of the front of the latch case 46. A switch actuator 84, which is mechanically coupled to the rotational drive member 62, slides along the longitudinal slot 82 when the rotational drive member 62 is rotated by the drive bar 64. Thus, a user may slide the switch actuator 84 along the longitudinal slot 82 by rotating the key 66 within the key-receiving body 70.

Referring to FIGS. 3, 4 and 5, the lock unit 10 further includes a switch 86 that is coupled to the control circuit and is situated along the path of the switch actuator 84. As illustrated in FIG. 5, when a user rotates the key 66 clockwise to a predetermined position, the switch actuator 84 triggers the switch 86, which, in turn, sends a signal to the control circuit. In a preferred embodiment, through a predetermined sequence of movements of the key 66 within the key-receiving body 70, the switch actuator 84 triggers the switch 86 in such a way as to send a series of signals to the control circuit to enable a “programming mode,” wherein a user is provided with the ability to program the lock unit 10. Once in “programming mode,” an indicator, e.g., a speaker 90, provides instructions in the form of voice prompts to guide a user through a “programming mode” and enables the user to achieve desired programming objectives. To that end, the lock unit 10 includes circuitry (not shown) for generating appropriate voice instructions. The lock unit 10 further includes an LED 92, which can also serve as an indicator, either alone or in combination with the speaker 90. For example, the LED 92 may provide instructions to a user in the form of flashing lights. Alternatively, the LED 92 may light up to indicate that the control circuit recognizes a biometric input provided to the fingerprint sensor 32.

Now that the essential structure of an embodiment of the present invention has been described, the operation of the same will now be described.

### Operation of the Lock Unit

Upon installation, the lock unit 10 would be immediately operable to be locked and unlocked using the key 66. However, the lock unit 10 of the present invention is unique in that the key 66 additionally enables a user to program the lock unit 10.

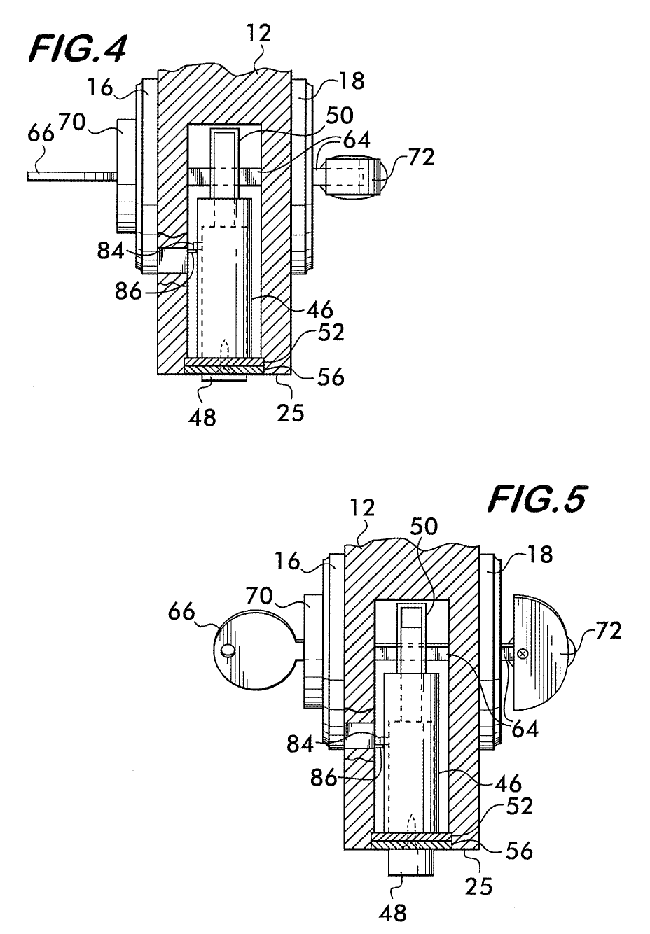

Upon installation of the lock unit 10, the control circuit contains no stored data corresponding to a biometric input of any user. A user will therefore first want to store biometric data associated with him/her in the control circuit. The first step to achieving this goal is to initiate the “programming mode.” Various methods of initiating the “programming mode” according to the present invention are contemplated. Written directions for doing so would be optimally included with the lock unit 10. According to one such method, the user would first insert the key 66 through the keyway 68 of the key-receiving body 70, while the door 12 is open. Next, the user would rotate the key 66 from its initial position (as illustrated in FIG. 4) clockwise until it can go no further (as illustrated in FIG. 5) and hold that position for five seconds, after which the user would rotate the key counterclockwise back to its initial position. In so doing, the user would be triggering and holding the switch 86 for a period of five seconds and then releasing it. The user would then repeat the same procedure, except that the user would additionally place his thumb onto the fingerprint sensor 32 while the key his held for five seconds in an extreme clockwise position. This type of selected positioning of the key 66 within the key-receiving body 70, coupled with the user placing his thumb over the fingerprint sensor 32, provides a three-point authentication to initiate “programming mode.” By requiring this type of authentication to initiate “programming mode,” it is ensured that the user will not inadvertently initiate “programming mode,” when, for example, he merely intends to use the key 66 to unlock the door 12. As should be appreciated by those skilled in the art, many other sequences of key movements can be used to establish the “programming mode.”

Upon initiating “programming mode,” a voice emanates from the speaker 90, giving instructions. One exemplary instruction may state: “Welcome to ‘programming mode.’ To enroll a new user, rotate your key clockwise until it can go no further and hold that position until you have received confirmation that you have initiated “enrollment mode.” All other programming features may be accessed through the ‘main menu.’ To go to the ‘main menu,’ leave the key in its initial position, until you receive further instructions.” Since the user would like to enroll himself/herself as a user of the lock unit 10, he/she would proceed to “enrollment mode.” Accordingly, the user would rotate the key clockwise until it cannot turn anymore and he/she would hold the key in that position for a predetermined period of time. Next, the voice instructions would say: “Welcome to ‘enrollment mode.’ To enroll a new user, place your thumb onto the fingerprint sensor and leave it until you are instructed to remove it.” The user would accordingly place his/her thumb onto the fingerprint sensor 32. The fingerprint sensor 32 thereby receives a biometric input from the user, i.e., a thumbprint, and provides an output signal to the control circuit representative of biometric data associated with the received thumbprint. The control circuit would then search its memory for stored biometric data corresponding to the data associated with the user's thumbprint. Upon finding no such stored data (there are currently no users enrolled), it would be confirmed that the user is, in fact, a new user. The voice from the speaker 90 would then instruct the user to remove his/her thumb from the fingerprint sensor 32 and then place his/her thumb back onto the fingerprint sensor 32 again, which the user would do. The voice would repeat the same instructions one last time and the user would again comply. The purpose behind this sequence is to allow the control circuit to check the quality of the biometric inputs provided by the user. If the quality is satisfactory, circuitry within the lock unit 10 would recognize that fact so that such circuitry would cause the speaker 90 to provide a voice saying: “You have successfully completed an enrollment template. You are ‘user number one.’ If you are satisfied with this, await further instructions. If you are not satisfied and you would like to start over, rotate the key clockwise as far as it will go and hold it in that position until you receive further instructions.”

Assuming that the user is satisfied, he/she would do nothing until he/she receives further instructions. After a predetermined period of time, the circuitry would produce a voice saying: “You are now in the ‘main menu.’ If you would like to enroll a new user or delete an enrolled user, rotate your key clockwise until it can go no further and hold that position until you have received confirmation that you have initiated ‘enrollment mode.’ If you would like to generate or modify access restriction parameters associated with an enrolled user, rotate the key clockwise until it can go no further and hold for about three seconds; release for a moment and then again rotate the key clockwise until it can go no further and again hold for about three seconds. If you would like to exit programming mode completely, please await exit confirmation.” The user wishes to exit, so he simply waits for a predetermined period of time until he hears the voice say: “You have exited programming mode. Goodbye.”

Once the user is enrolled, he/she can open the lockbolt 48 from outside the door 12 either by using his key 66 in the standard manner, or by placing his/her thumb over the fingerprint sensor 32.

Suppose now that the user is having work done in his house by a contractor. The contractor will be in his house on Mondays, Wednesdays and Thursdays for the next month. The user will not always be home to let the contractor in. Instead of giving the contractor a key, the user may enroll the contractor as a user of the lock unit 10. To do so, the user would initiates the “programming mode” and “enrollment mode,” as described above, while the contractor is present. Once in “enrollment mode,” the user would have the contractor place his thumbprint onto the fingerprint sensor 32 and follow the instructions provided by the voice from the speaker 90 in order to enroll the contractor as a new user. After the contractor follows the instructions provided, which are virtually the same as those earlier followed by the user to enroll himself, the contractor will have successfully created an enrolment template for himself. The voice from the speaker would then inform the contractor: “You are ‘user number two.’” If the user would like to generate access restriction parameters associated with “user number two” (the contractor), but would prefer not to do so in the presence of the contractor, the user would exit “programming mode” for the time being.

After the contractor has left for the day, the user would initiate “programming mode” and proceed to the “main menu” as per instructions provided by the voice from the speaker 90. Once in the “main menu,” the user would follow the voice instructions to select an option to generate access restriction parameters associated with “user number two.” To that end the voice produced would instruct the user on how to limit the days and times when the contractor can open the lock unit 10. The user would then move the key in the key-receiving body according to a predetermined sequence of movements as instructed by the voice so as to limit the contractor's ability to open the lock unit 10 to predetermined times, e.g., Mondays, Wednesdays and Thursdays, between 6:00 AM and 9:00 PM. Thus, if the contractor attempted to open the lock unit 10 using his thumbprint on any other day or at any other time, the control circuit would not actuate the motor 74 to unlock the lockbolt 48.

After the contractor has completed all of his work in the house, if the user would no longer want the contractor to be enrolled as a user of the lock unit 10, the contractor's biometric data can be deleted. To delete that data, the user would first initiate “programming mode” as described supra. Upon initiating “programming mode,” the user would follow a series of instructions in order to select and delete “user number two” from the memory of the control circuit. Once “user number two” is deleted, the contractor will no longer be able to open the lock unit 10 using his thumbprint at any time.

The foregoing description of the operation of the lock unit 10 is but one example illustrating a possible mode of operation. There are virtually endless possibilities in terms of the exact manner in which the invention may operate. The sequence of movements of the key in the key-receiving body 70 to effectuate programming of the lock unit 10 may vary from the sequence described herein. Moreover, the type of indicator and form of instructions provided may also vary. For example, the lock unit 10 may have no speaker 90 at all, but just a LED 92, in which case the instructions may be provided in the form of flashing lights. Alternatively the speaker 90 may provide instructions only in the form of various electronic tones, instead of a speaking voice. It is preferred, however, that the instructions be at least in the form of voice prompts. Additionally, although it is preferred that the key used to open and program the lock unit 10 is a conventional key 66 such as that shown in FIGS. 1-5, the full scope of the invention is not limited only to use of conventional keys. For example, the invention may use magnetic key cards such as those often used in the hotel industry, or RFID key cards such as those often used in a commercial setting. For those types of key cards, the key-receiving body would be a structure capable of scanning and reading such cards.

It should be apparent that the invention as described and claimed herein should be simple and intuitive to program, as it incorporates the familiar motion of turning a key in conjunction with clear instructions to help a user navigate through, and select various options. Moreover, although it is possible that a keypad and/or LCD screen could be provided in connection with the invention, such features should be unnecessary because a user can program the lock unit 10 using only his key 66. The biometric sensor (e.g., fingerprint sensor 32) is the only potential outwardly visible biometric component of the lock unit 10. However, even the biometric sensor can be hidden from plain view. For example (according to embodiments of a lock unit according to the present invention not shown in the drawing figures), the biometric sensor can be shielded from view by an openable cover or obscured behind or underneath a portion of the outside structure of the lock unit. As such, the lock unit 10 can retain, as much as possible, the traditional and elegant look of a standard mechanical key-entry lockset. Ultimately, a lock unit according to the present invention can come in any appearance, shape, style and size, without having its appearance substantially influenced by components normally associated with biometric locks.

While the invention has been described in detail and with reference to specific examples thereof, it will be apparent to one skilled in the art that various changes and modifications can be made therein without departing from the spirit and scope thereof.

What is claimed is:

1. A lock unit comprising a housing including a key-receiving body, a biometric sensor and a control circuit, the key-receiving body being arranged to receive a key therein, the biometric sensor being adapted to receive a biometric input from a user of the lock unit and to provide an output signal representative of biometric data associated with that user, the control circuit being coupled to the biometric sensor and arranged when actuated to store the biometric data therein, the control circuit being coupled to the key-receiving body and operative upon selected positioning of a key in the key-receiving body to actuate the control circuit, whereupon the biometric data is stored in the control circuit so that subsequent receipt of a biometric input corresponding to the stored biometric data enables the lock unit to open.

2. The lock unit of claim 1, wherein a predetermined sequence of movements of the key in the key-receiving body actuates the control circuit to generate access restriction parameters associated with the biometric data stored in the control circuit, the access restriction parameters being operative to limit the times during which subsequent receipt of a biometric input corresponding to the stored biometric data enables the lock unit to open.

3. The lock unit of claim 1, wherein a predetermined sequence of movements of the key in the key-receiving body actuates the control circuit to delete the biometric data stored in the control circuit.

4. The lock unit of claim 1, wherein the selected positioning of the key in the key-receiving body comprises a predetermined sequence of movements of the key in the key-receiving body that actuates the control circuit to store the biometric data in the control circuit.

5. The lock unit of claims 2, 3 or 4 further comprising a switch, the switch being coupled to the control circuit and the key-receiving body, whereupon the predetermined sequence of movements of the key in the key-receiving body triggers the switch to actuate the control circuit.

6. The lock unit of claims 2, 3 or 4 further comprising an indicator, the indicator being coupled to the control circuit and being operative to provide instructions to the user relating to the predetermined sequence of movements.

7. The lock unit of claim 5, wherein the indicator is a speaker, a light or a combination thereof.

8. The lock unit of claim 6, wherein the instructions are in the form of voice prompts, flashing lights, audible electronic tones or a combination thereof.

9. The lock unit of claim 1, wherein the key is a conventional key.

10. The lock unit of claim 1, wherein the biometric sensor is a fingerprint sensor and the biometric input is a fingerprint or thumbprint.

11. A biometric lock unit and key combination wherein the key enables a user to both open the biometric lock unit and store biometric data in a control circuit of the biometric lock unit, the biometric lock unit comprising a housing including a key-receiving body and a biometric sensor, the key-receiving body being arranged to receive the key therein, the biometric sensor being adapted to receive a biometric input from the user and to provide an output signal representative of biometric data associated with that user, the control circuit being coupled to the biometric sensor and arranged when actuated to store the biometric data therein, the control circuit being coupled to the key-receiving body and operative upon a first selected positioning of the key in the key-receiving body to actuate the control circuit, whereupon the biometric data is stored in the control circuit so that subsequent receipt of the biometric input corresponding to the stored biometric data enables the lock unit to open, the key-receiving body being operative upon a second selected positioning of the key therein to open the lock unit.

12. A method of programming a biometric lock unit, the biometric lock unit comprising a housing including a key-receiving body, a biometric sensor and a control circuit, the key-receiving body being arranged to receive a key therein, the biometric sensor being adapted to receive a biometric input from a user of the lock unit and to provide an output signal representative of biometric data associated with that user, the control circuit being coupled to the biometric sensor and arranged when actuated to store the biometric data therein, the control circuit being coupled to the key-receiving body and providing a programming mode through which programming of the biometric lock unit can be effectuated, the method of programming the biometric lock unit comprising the steps of accessing the programming mode through selective positioning of the key in the key-receiving body and, upon initiating the programming mode, moving the key according to a predetermined sequence of movements in the key-receiving body so as to actuate the control circuit, thereby programming the biometric lock unit.
